(19) United States
(12) Patent Application Publication
(10) Pub. No.: US 2024/0063598 A1
(43) Pub. Date: Feb. 22, 2024

(54) HIGH POWER RAMAN FIBER LASER

(71) Applicant: Raytheon Company, Arlington, VA (US)

(72) Inventors: Fabio Di Teodoro, Hacienda Heights, CA (US); David A. Rockwell, Culver City, CA (US)

(21) Appl. No.: 17/891,009

(22) Filed: Aug. 18, 2022

(51) Int. Cl. H01S 3/067; H01S 3/094; H01S 3/10; H01S 3/16; H01S 3/30

(52) U.S. Cl. CPC H01S 3/06716; H01S 3/094007; H01S 3/10023; H01S 3/10084; H01S 3/1616; H01S 3/302

(57) ABSTRACT

A high-power Raman fiber laser includes: a seed laser; a plurality of pump lasers, each including a cladding and comprising of thulium-doped fiber laser (TDFL) and configured to operate in a 1935-2020 nm spectral window; a pump/seed combiner to combine outputs of the pump lasers and output of the seed laser and having a tapered portion including a cladding; and a Raman fiber amplifier having a core and a cladding surrounding the core, the seed laser is launched into the core, and pump laser output beams are launched into the cladding, to amplify the seed laser to produce an amplified output signal, and a brightness of the cladding of the Raman fiber amplifier is matched to a combined brightness of the plurality of pump lasers.

### FIELD OF THE INVENTION

The present disclosure generally relates to Raman fiber lasers, and more particularly to high-power Raman fiber lasers operating at long wavelengths.

### BACKGROUND

Fiber lasers have emerged as the solution of choice for applications requiring high emitted power; good beam quality; low size, weight, and power consumption (SWaP); and rugged build suitable to field-deployed platforms. Special applications, including directed energy and advanced long-range LiDAR, are accompanied by a long list of challenging performance requirements, which may strain the fiber laser design.

In recent years, Tm-doped fiber lasers (TDFLs) have become established as a viable approach for generating continuous-wave (CW) and pulsed laser waveforms in the desirably eye-safe spectral range with CW average power capabilities extending beyond 1 kW and electrical-to-optical (E-O) efficiencies of ˜20%. At the same time, pulsed waveforms have been demonstrated having ˜100 kW peak power and good spectral brightness. Despite this recently attained maturity, fundamental limitations hamper a more widespread adoption of TDFLs in applications of military, scientific, and industrial interest.

Typically, TDFLs are not ideal for advanced LiDAR and directed energy (DE) applications, which may require beam propagation through the atmosphere over relatively long distances (>1 km) at relatively low altitude (<3000 m). In fact, the relevant TDFL emission lies almost entirely within a prominent feature in the near-infrared absorption spectrum of atmospheric water vapor, namely the “v₂+v₃” vibrational combination band of H₂O, which is centered at ˜5260 cm⁻¹ (˜1900 nm) and ascribed to the combined asymmetric stretch of the O—H and bending of the H—H molecular bonds.

FIG. 1 illustrates a simulated peak-normalized spectral transmittance of a laser beam propagating through the atmosphere as a function of wavelength. The simulation assumes propagation over 150 km range in a straight path at 3 km altitude (˜10,000 ft.) within rural atmosphere with clear visibility (102) for a practical spectral window for Thulium (Tm)-doped fiber laser emission. The dashed-line rectangle shown represents the spectral region over which TDFLs are practical, i.e., where they operate at required power levels with acceptable efficiency. As depicted, most of Tm-doped fiber direct emission experiences substantial loss compared to light in the 2100-2200 nm window.

Several techniques have been attempted in the art to overcome the spectral-coverage shortcomings of TDFLs. Some approaches have yielded sufficient output power from TDFLs operating at 2100 nm, with good efficiency, but only in CW form and limited to the mere short-wavelength edge of the desirable 2100-2200 nm spectral window.

Besides their unfavorable emission wavelength subject to considerable atmospheric absorption, TDFLs are also challenging to individually power-scale to required levels. In some cases, TDFLs might be required to emit output average power in excess of 1 kW while exhibiting diffraction-limited single-transverse-mode (STM) spatial beam quality and narrow spectral linewidth<1 GHz to facilitate applications such as coherent beam combining. In other cases, such lasers may be required to emit short (e.g. few-nanosecond long) pulses having high peak power (e.g. 10 s of kW or higher) and narrow spectral linewidths (e.g. Fourier-transform time/bandwidth limited), consistent with applications of coherent or direct-detection active (laser-based) remote sensing, including long-range LiDAR.

FIG. 2A shows the absorption cross-section of Tm-doped fibers, indicating major absorption features usable for optical pumping, and FIG. 2B depicts a Jablonski diagram of relevant energy states in Tm ions illustrating the 2-for-1 cross-excitation process. In TDFLs required to generate kW-class average power, it is especially challenging to manage the waste heat generated by the process of optical pumping without degrading other figures of merit, such as beam quality and especially SWaP. TDFLs are typically pumped by ˜790 nm diode lasers, which yield a pump/emission quantum defect ˜60%. Here, the quantum defect (QD) is defined as:

QD=1−λₚᵤₘₚ/λₗₐₛₑᵣ,

where λₚᵤₘₚ₍ₗₐₛₑᵣ₎ denotes the TDFL diode-pump (emission) wavelength.

The high QD value compares unfavorably with the QD<10% of Yb-doped fiber lasers, which are, in fact, the most proven and widely adopted fiber lasers for directed energy applications. A consequence of the higher QD is that a greater amount of waste heat is deposited into the fiber. At kW-power levels, excess waste heat may increase the temperature at the fiber outer surface beyond the softening point of fiber jacket materials (˜100° C.) and, thus, lead to mechanical fiber failure of the TDF. Increasing the Tm doping concentration in the core of TDFLs is known for boosting their optical efficiency through a process of resonant inter-ion cross-relaxation, schematically illustrated in FIG. 2. However, the increased optical-to-optical (O—O) efficiency does not solve the thermal management problem. In fact, the high Tm-doping concentration (e.g., in excess of 5% wt.) required to realize a strong cross-relaxation effect, combined with the high value of absorption cross-section (˜9×10⁻²⁵ m²) at the ˜790 nm pump wavelength, results in high pump absorption per unit length and, consequently, high heat load (defined as waste heat deposited per unit length) and unchanged, or worse, outlook for the fiber jacket overheating and failure.

Accordingly, there is a need for laser architecture for generating laser emission spanning the 2100-2200 nm spectral window and supporting quasi-CW operation with ˜1 kW average optical power that is useful in directed-energy applications.

### SUMMARY

In some embodiments, the present disclosure addresses the challenges in developing a design for a Raman fiber laser that is capable of efficient generation of a high-power output beam in the wavelength range of 2100 to 2200 nm with good output beam quality. In some embodiments, the pump for this Raman-based laser source uniquely combines multiple individual, high-efficiency Tm-doped fiber lasers (TDFLs), and launches the output beams from these individual lasers into a Raman fiber amplifier. The fiber that functions as the Raman amplifier uniquely enables the final integrated laser to yield output power levels, beam quality, and efficiency that are superior to any prior attempts to access this target wavelength range.

In some embodiments, the disclosure is directed to a method for operating a high-power laser. The method includes: operating a seed laser in a first spectral window; operating a plurality of pump lasers in a second spectral window, each including a cladding and comprising of thulium-doped fiber laser (TDFL); combining outputs of the pump lasers and output of the seed laser using a pump/seed combiner having a tapered portion including a cladding; and amplifying the seed laser, using a Raman fiber amplifier having a core and a cladding surrounding the core, to produce an amplified output signal having a wavelength in the first spectral window, wherein the seed laser is launched into the core, and pump laser output beams are launched into the cladding.

In some embodiments, the number of the plurality of pump lasers Nₘₐₓ is given by:

$$\\ \begin{matrix}{N}_{max} = {( \frac{{d}_{R} \times {NA}_{R}}{{d}_{TDFL} \times {NA}_{TDFL}} )}^{2} . & ( 2 )\end{matrix}$$

where, d_{R} and NA_{R} denote the pump-cladding diameter and pump-cladding numerical aperture (NA) of the Raman fiber amplifier, and where d_{TDFL} and NA_{TDFL} denote the core diameter and core NA of the terminal fiber in each of the pump TDFLs.

In some embodiments, the seed laser is configured to operate in a 2100-2200 nm spectral window. In some embodiments, the brightness of the Raman fiber amplifier is configured to match to the cladding of the tapered portion of the pump/seed combiner. In some embodiments, the pump/seed combiner is fusion-spliced with the Raman fiber amplifier.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 illustrates a simulated peak-normalized spectral transmittance of a laser beam propagating through the atmosphere as a function of wavelength.

FIG. 2A shows absorption cross-section of Tm-doped fibers showing major absorption features usable for optical pumping, and FIG. 2B depicts a Jablonski diagram of relevant energy states in Tm ions illustrating the 2-for-1 cross excitation process.

FIG. 3 depicts a schematic view of an example of a high-power Raman fiber laser, according to some embodiments of the disclosure.

FIG. 4 illustrates a schematic view of a pump Thulium (Tm)-doped fiber lasers (TDFLs) architecture, according to some embodiments of the disclosure.

FIG. 5 shows some examples of pulse waveforms generated by a Raman fiber laser, according to some embodiments of the disclosure.

FIG. 6 is a schematic view of an exemplary architecture for a seed laser, according to some embodiments of the disclosure.

FIG. 7 is a schematic view of an exemplary fiber-based pump/seed combiner component, according to some embodiments of the disclosure.

FIG. 8 depicts a graph illustrating maximum number of TDFLs that can be used to pump a Raman fiber amplifier without introducing any optical insertion loss, according to some embodiments of the disclosure.

FIG. 9 depicts a cross-section of a gain-filtering fiber, according to some embodiments of the present disclosure.

FIG. 10 shows a circular cross section of several pump beams positioned for launch into a Raman fiber amplifier, according to some embodiments of the present disclosure.

FIG. 11 illustrates the different power spectral densities for pulses having different temporal profiles, but same peak power, duration and wavelength, propagating through the same fiber, according to some embodiments of the present disclosure.

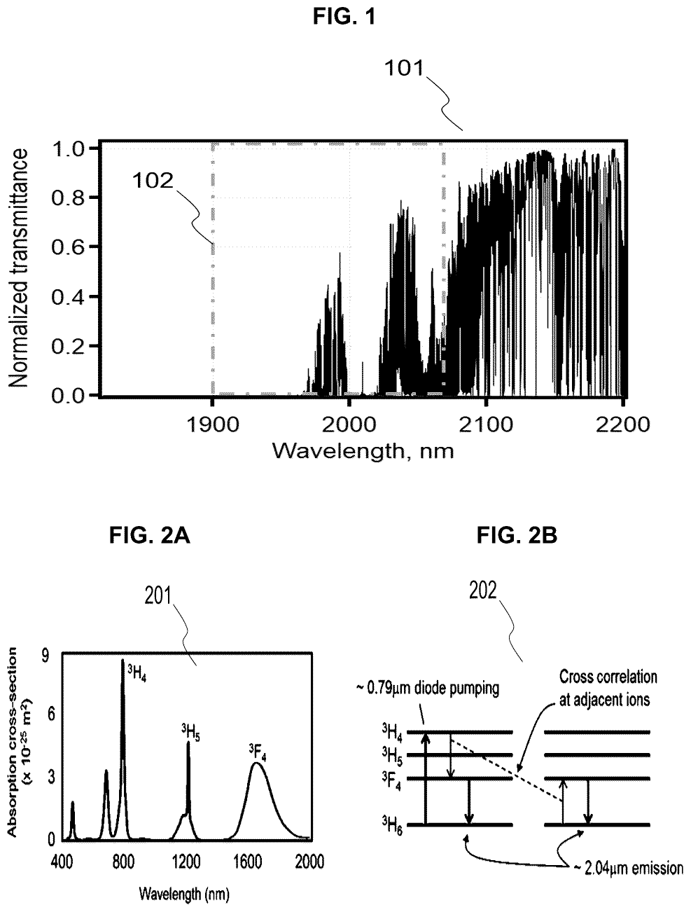

### DETAIL DESCRIPTION

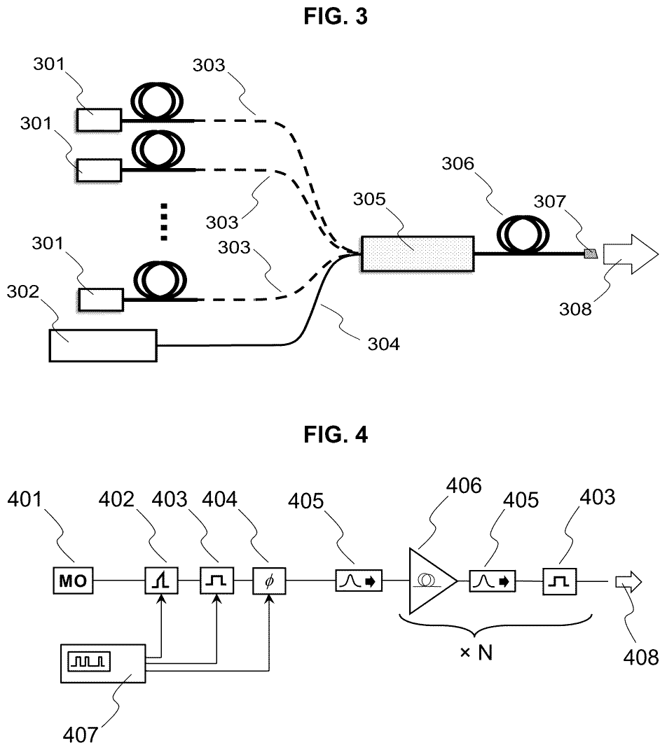

FIG. 3 depicts a schematic view of an example of a high-power Raman fiber laser, according to some embodiments of the disclosure. As shown several pump lasers 301, each comprising of thulium-doped fiber laser (TDFL) and operating in the ˜1935-2020 nm spectral window, are used to pump a seed laser 302 that includes fiber laser operating in the 2100-2200 nm spectral window, e.g., the operating wavelength of the laser is in the 2100-2200 nm spectral range. A pump/seed combiner 305 combines the outputs 303 of the pump lasers 301 and output 304 of the seed laser 302, and inputs the combined lasers to a Raman fiber amplifier 306. An optional beam-expanding endcap 307 protects the tip of the high-power fiber laser against optical damage and outputs an output beam 308.

As illustrated in FIG. 3, the disclosed laser architecture comprises one or more suitably designed TDFLs, which are used as pump lasers 301. The architecture also comprises one or more suitably designed fiber-based seed laser 302. Pump and seed lasers are together optically coupled via a fiber-based combiner 305 into an exit fiber used as a Raman fiber amplifier. The principle of operation of a Raman amplifier is to transfer power from the pump to the seed laser, this power transfer being especially effective when the seed laser is redshifted in wavelength with respect to the pump laser by an amount Δε, such that the quantity Δε, given by:

Δε=hc|Δλ|/λₚ², (1)

This corresponds to the fraction of pump-beam photon energy spent into exciting matter vibrations (also referred to as optical phonons) within the Raman-active material in the Raman amplifier. Relevant values of ΔE reflect specific properties of the Raman-active material. In Eq. (1), c denotes the vacuum speed of light, h is Planck's constant, and λₚ is the pump-beam wavelength.

In the architecture of FIG. 3, the seed laser 302 operates at a wavelength λₛ within the 2100-2200 nm wavelength window. The value of λₛ may be dictated by specific application requirements. In some embodiments, the TDFLs pump lasers all operate at the same pump wavelength λₚ, which must satisfy λₚ=λₛ−|Δλ|, where Δλobeys Eq. (1).

In some embodiments, the Raman fiber amplifier includes germanium (Ge)-doped fused silica as the Raman active material. In Ge-doped fused-silica fibers, the Raman gain peaks at Δε˜0.054 eV, which corresponds to an optical frequency shift ˜13 THz. By substituting this value of Δε into Eq. (1), the pump wavelength λₚ correspondingly lies within the ˜1935-2020 nm window, for effective power-transfer via Raman process into a seed having wavelength λₛ in the 2100-2200 nm window. In this spectral region, the pump TDFLs are known to conveniently operate at peak optical efficiency. Moreover, the high-power Raman laser of the present disclosure does not require anomalously high Ge doping concentrations, which might complicate fiber fabrication and diminish reliability. As a result, the disclosed architecture is both practical and readily sourced from commercially available components, and affords high overall efficiency as the optical efficiency of the Raman fiber amplifier can approach the pump/seed quantum defect limit (>90%), not being diminished by excess loss caused by material impurities and other imperfections typical of immature fibers.

In some embodiments, additional innovative concepts, which are described in detail below, are included in the laser architecture to be uniquely viable for advanced LiDAR and directed-energy applications. These concepts include one or more of specific pulsed regimes of operation, fiber-optic components and specialty fiber characteristics to further improve the architecture.

FIG. 4 illustrates a schematic view of a pump Thulium (Tm)-doped fiber laser (TDFL) architecture, according to some embodiments of the disclosure. A master oscillator (MO) 401 (for example, a single-frequency diode or fiber laser operating in the ˜1935-2020 nm wavelength window) provides the clocking signal for the pump laser and produces a continuous wave (CW) waveform at the desired pump wavelength. In some embodiments, MO 401 is a single-longitudinal-mode (i.e. single-frequency) laser source. In some embodiments, the MO is a fiber-coupled distributed-feedback or distributed Bragg reflector semiconductor laser operating at a chosen wavelength within our designated operational spectra range. In some embodiments, the MO may be a fiber-coupled semiconductor laser equipped with an external cavity comprising a dispersive element such as a volume Bragg grating and emitting light within the spectral window mentioned above. In some embodiments, the MO may be a distributed-feedback TDFL operating in the same spectral ˜1935-2020 nm spectral window.

MO 401 is followed by an electro-optic intensity modulator 402, such as an electro-optic lithium-niobate Mach-Zehnder modulator driven by an electronically generated voltage waveform and designed to chop the CW emission from the MO into a stream of optical pulses. Two optical pulse formats are of interest for LiDAR and directed-energy applications. An optional electro-optic time-gating intensity modulator 403 increases the on/off pulse contrast. An optional electro-optic phase modulator 404, is used to impart application-driven phase patterns. Control electronics 407 provide controls for Electro-optic intensity modulator 402, optional electro-optic time-gating intensity modulator 403 and optional electro-optic phase modulator 404.

A fiber-coupled bandpass filter and Faraday optical isolator 405 suppresses broadband amplified spontaneous emission and optical feedback, respectively. A Tm-doped amplifier fiber chain 406 combined with another fiber-coupled bandpass filter and Faraday optical isolator 405 and optional electro-optic time-gating intensity modulator 403 (N is the number of amplifier stages, e.g., 2 or 3) provides signal amplification to produce the output beam 408.

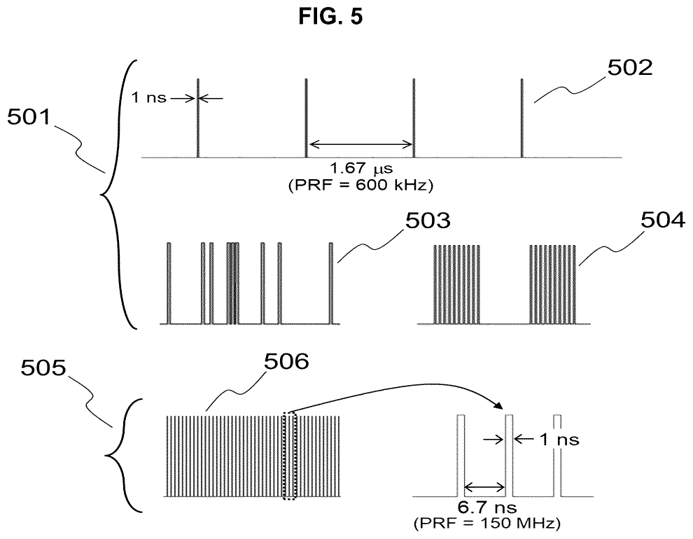

FIG. 5 shows some examples of pulse waveforms generated by a Raman fiber laser, according to some embodiments of the disclosure. Item 502 is an example of a periodic (repetitive) pulse sequence; item 503 is an example of a waveform based on pulse-position modulation; item 504 is an example of a waveform based on pulse bursts; item 505 is an example of a pulse waveform used for directed-energy applications; and item 506 is an example of a high duty-cycle (quasi-CW) pulse waveform.

As shown, for LiDAR applications, it is desirable to generate nanosecond-long pulses at pulse repetition frequency (PRF) of 10 s to 100 s of kHz and, in some cases, higher (>1 MHz). In particular, pulses of ˜1 ns duration are especially desirable, because they are short enough to yield ˜30 cm range resolution (typically viable for long-range LiDAR), but long enough to avoid the need for broadband (>1 GHz) processing optoelectronics that might be difficult to ruggedize for harsh field-deployment conditions.

For directed energy applications, a TDFL optical intensity modulator (e.g., the electro-optic intensity modulator 402 in FIG. 4) is driven to generate a high-duty-cycle quasi-CW pulse format. An example of such pulse format is a repetitive stream of ˜1 ns pulses at PRF>100 MHz, which corresponds to pulse duty cycle>10%, where the duty cycle δ is defined as δ=τ×PRF, τ being the pulse duration. This quasi-CW pulse format is chosen to yield high average power P_{avg}˜Pₚₑₐₖ×δ, where Pₚₑₐₖ is the pulse peak power. The maximization of average power is, in turn, required to maximize lethality of the laser as part of a directed-energy weapon system as the extent of laser-induced damage on a remote target depends on deposited laser energy E=P_{avg}×Δt where Δt is the laser beam dwell time on target. Δt the same time, the pulse duration can be chosen to be 1 ns to suppress SBS. In some embodiments, the high pulse repetition frequency is between 100 MHz and 1 GHz, and the pulse duty factor is between 1-50%.

The pulse format is designed to yield high peak power Pₚₑₐₖ of at least several kW or higher. The high value of Pₚₑₐₖ maximizes the efficiency of the Raman amplification process for which the TDFLs are intended to serve as the pump source. In addition to increasing the Raman amplification efficiency, LiDAR applications specifically require high pulse energy and peak powers to maximize the return signal at a given range. In order to maximize pulse energy and peak power, the pulse streams generated by each member of the TDFL array are time-synchronized so that the pulse energies and peak power stack additively. In some embodiments, as a way to ensure such pulse synchronization, a single MO may be used as the starting point for all TDFLs in the array. In directed-energy applications, the pulses can be synchronized or not, given that only average power matters in this case. In particular, in such applications, the pulses can be time-synchronized to maximize Raman amplification efficiency.

Besides producing these programmed pulse formats, the TDFLs also generate high pulse power, which is obtained by transmitting the intensity-modulated pulsed MO output through a series of Tm-doped amplifier fibers, as shown in FIG. 4. Using multiple amplifiers in series permits to stage the overall optical gain in such a way that, between stages, ASE can be removed, which in turn maximizes energy extraction by the pulses being amplified. ASE removal is performed by means of inter-stage fiber-coupled bandpass filters centered at the TDFL wavelength and typically featuring a pass-band of few-nm width. Faraday optical isolators are also inserted between stages, in some embodiment within the same fiber-coupled components as the bandpass filters.

In some embodiments, the Tm-doped fibers used in the individual amplifier chains in FIG. 3, which are schematically represented in FIG. 4, satisfy several requirements. First, they are double-clad so as to support cladding-pumping by˜790 nm multimode-fiber-coupled diode lasers, which can deliver high pump power into the pump cladding of the Tm-doped fiber by means of fusion-spliced pump-injection components that combine the λₚ-wavelength signal being amplified by the Tm-doped fiber and the diode pump beam. Second, their core diameter and numerical aperture are such that either a STM or few-transverse-mode beam of relatively good spatial quality and high brightness is emitted from each Tm:fiber. In some embodiments, for example, the largest core diameter in the Tm-doped fibers of the amplifier chain is 15 μm and the corresponding core NA is 0.1, which yields STM operation at 1945 nm. Third, the amplifier fibers are highly Tm-doped, with Tm concentration exceeding 5% wt.

In some embodiments, the generation of high power from TDFLs maximizing the pump power for the Raman fiber amplifier is obtained by increasing the number of elements in the TDFL array while operating each TDFL within safe limits, rather than attempting to power-scale individual TDFLs beyond conditions for practical thermal management.

Efforts for scaling Raman fibers to wavelengths in the long-wave regime have been made earlier, but at lower power levels. For example, starting with a Yb:Er pump laser operating at 1608 nm, a sequence of 4 consecutive Stokes shifts in a single Raman fiber amplifier produced an output wavelength of 2200 nm. However, the power was <1 W, and no report was made of the beam quality. There are no current demonstrations from others, nor any obvious indications of near-term demonstrations from others of either high-power CW or pulsed Raman fiber lasers in the desired spectral range of 2100-2200 nm.

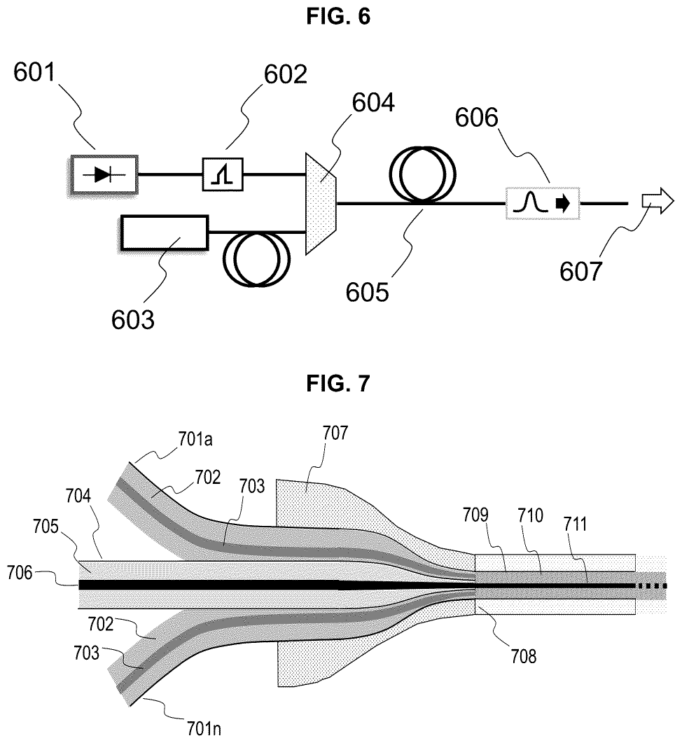

FIG. 6 is a schematic view of an exemplary architecture for a seed laser, according to some embodiments of the disclosure. In this example, the seed laser is all-fiber-coupled and comprises a master oscillator 601 (e.g. a single frequency distributed-feedback, distributed Bragg-reflector, or external-cavity fiber-coupled diode laser) emitting light at the desired wavelength within the 2100-2200 nm spectral window. The fiber-guided master oscillator output beam is transmitted through a fiber-coupled intensity modulator 602 (for example, an electro-optic Mach-Zehnder modulator). In some embodiments, the seed laser also comprises a single TDFL 603, for example, a Thulium (Tm)-doped fiber laser source acting as a Raman pump source operating at an appropriate wavelength in the ˜1935-2020 nm window. TDFL 603 emits a stream of pulses which are the same in shape and duration and time-synchronized to those generated by the master-oscillator modulator. The wavelength of this TDFL is the same as the wavelength of the array of TDFLs described above. The modulated master-oscillator output and TDFL output beams are injected into input fiber ports of a single-transverse-mode combiner 604, such as, a wavelength-division multiplexer.

The output of the combiner 604 is fusion-spliced to a Raman fiber 605 utilized as a Raman fiber amplifier to transfer power from the pumping TDFL to the master-oscillator output beam. The output of the Raman fiber is finally transmitted through a fiber-coupled optical bandpass filter and Faraday optical isolator 606 (for example, integrated in the same component) to generate an output beam 607. In some embodiments, the architecture of the seed laser itself is structurally similar to the architecture of the Raman fiber laser source shown in FIG. 3, but it is simpler and may be based on readily available off-the-shelf components, because the seed laser is tasked to generate a significantly lower power in the 2100-2200 nm spectral window. In some embodiments, the optical power from the intensity-modulated master oscillator is sufficient and therefore the TDFL, combiner, and Raman fiber in FIG. 6 can be omitted. Other embodiments are also possible using some or all of the components illustrated in FIG. 6.

In some embodiments, the seed laser generates a beam having a wavelength in the 2100-2200 nm window, with the specific value of the wavelength being dictated primarily by the intended application. In some embodiments, the seed laser generates optical pulses that are time-synchronized, i.e., overlapped in time with the pulses generated by the pump TDFLs described above. In some embodiments, these pulses exhibit a narrow optical spectrum consistent with LiDAR or directed-energy applications that require high spectral brightness for reasons that include spectral discrimination against a broader background and beam combining. In some embodiments, the seed-laser generated optical pulses are time/bandwidth Fourier-transform limited.

FIG. 7 is a schematic view of an exemplary fiber-based pump/seed combiner, according to some embodiments of the disclosure. The fiber-based pump/seed combiner (hereafter referred to as “fiber combiner” and abbreviated as FC) combines the pump beams from the array of TDFLs shown in FIG. 3 and the seed beam from the seed laser described above. As shown, the FC is implemented as a tapered fiber-bundle construct. As shown, a cladding input pigtail 702 is brightness-matched to the TDFL fiber cladding. Item 703 is core of the input pigtails, brightness-matched to the TDFL fiber core; item 704 is a seed-carrying input pigtail fiber, meant to be fusion-spliced to the seed-laser output fiber; item 705 is the cladding of the seed-carrying fiber, size-matched to the cladding of the seed-laser output fiber; and item 706 is the core of the seed-carrying fiber, brightness-matched to the core of the seed-laser output fiber. Furthermore, item 707 is a capillary tube enclosing the combiner fiber bundle; item 708 is a fusion splice between tapered portion of the combiner and input portion of the Raman-fiber amplifier; item 709 is the input portion of the Raman fiber amplifier; item 710 is the cladding of the Raman fiber amplifier, brightness matched to the cladding of the tapered portion of the pump/seed combiner; and item 711 is the input portion of the core of the Raman fiber amplifier, brightness-matched to the core of the seed-carrying fiber.

In this example, the FC includes multiple input pigtail fibers which, in some embodiment, are each connected to a pump TDFL for example as a delivery fiber and configured to receive pump light from one corresponding pump TDFL. The FC also features an input pigtail fiber, which is configured to receive the seed signal from the seed laser source described above.

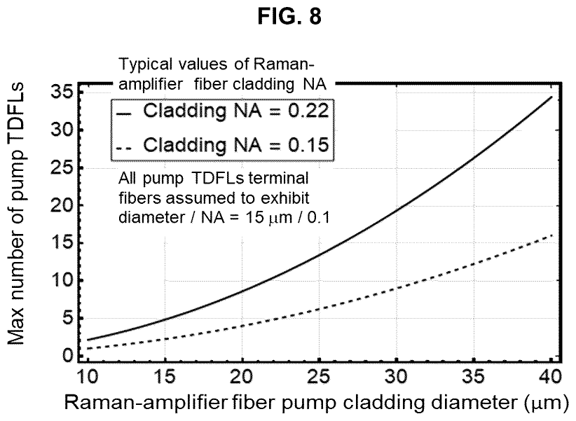

FIG. 8 depicts a graph illustrating the maximum number of TDFLs that can be used to pump a Raman fiber amplifier without introducing any optical insertion loss, according to some embodiments of the disclosure. As depicted in the graph, the maximum number of TDFLs that can be used to pump the Raman fiber amplifier without introducing any optical insertion loss is a function of the Raman-fiber amplifier cladding diameter. In this example, the core diameter/NA of the terminal fiber of each TDFL is 15 μm/0.1, and the two NA values of 0.22 and 0.15 are considered for the cladding of the Raman fiber amplifier.

In some embodiments, each of the fibers in the input portion of the FC may include a core, cladding, and an outer surface consisting of a polymer jacket or jacketed glass-based outer cladding material. Some aspects of the FC include: (a) all input fibers are stacked together, bundled and heat-tapered into a common exit fiber such that both guiding cladding and core of this exit fiber match the spatial brightness of the Raman fiber amplifier (described below); (b) this FC exit fiber is fusion-spliced to the Raman fiber amplifier in such a way the light guided in both the core and cladding of the FC exit fiber is injected into the Raman fiber amplifier with negligible insertion optical loss occurring at the splice location; (c) unlike components similar in construction to the FC discussed here and described in the art as being used to combine pump and seed beams into the cladding and core, respectively, of a rare-earth-doped amplifier fiber (including such components used, for example, in the construction of individual TDFLs as described above), the FC in FIG. 6 is primarily aimed at combining beams originating in the pump TDFLs and seed laser, all of which have high spatial brightness, including, for example, STM beams, and this high spatial brightness is retained in all of the beams propagating in the FC input fibers.

This high-spatial-brightness design enables the FC exit fiber to match the etendue of the Raman fiber amplifier, including Raman fiber amplifiers featuring a considerably smaller pump cladding compared to the pump cladding of the conventional rare-earth-doped fibers. The design criterion of etendue (or spatial-brightness) matching between FC and the Raman fiber amplifier to which the FC exit fiber is fusion-spliced is further illustrated in FIG. 8. Here, we consider an embodiment of FC built with pump-TDFL delivery fibers at the FC input portion, each having core diameter of 15 μm and core NA=0.1, such that each of said fibers exhibits STM guidance at 1945 nm.

The plot in FIG. 8 thus shows the maximum number of such fibers which can be stacked and bundled together and ultimately form the exit fiber that will be spliced to the Raman amplifier fiber. This maximum number, Nₘₐₓ, is computed based on the etendue conservation (i.e. etendue matching or spatial-brightness matching) relationship:

$$\\ \begin{matrix}{N}_{max} = {( \frac{{d}_{R} \times {NA}_{R}}{{d}_{TDFL} \times {NA}_{TDFL}} )}^{2} . & ( 2 )\end{matrix}$$

Here, d_{R} and NA_{R} denote the pump-cladding diameter and pump-cladding NA of the Raman fiber amplifier, whereas d_{TDFL} and NA_{TDFL} denote the core diameter and core NA of each of the terminal fiber in each of the pump TDFLs. In the example illustrated in FIG. 8, it is then observed that 10 s of pump TDFLs can be used in typical embodiments of this invention, which ultimately provides a path to considerable scaling of pump power going into the Raman amplifier.

In some embodiments, the input pigtail fibers in the FC can be tightly stacked or otherwise positioned within a capillary tube, a portion of which is shown as 707 in FIG. 7. This capillary tube may be formed from any suitable material(s), such as glass. The capillary tube can be sized and shaped so that all FC input pigtail fibers form a closely-packed array or other arrangement within the capillary tube. In one example of this construction, the input pigtail fiber transporting the seed beam originating from the seed laser described above is positioned in the center of the capillary tube, and the input pigtail fibers transporting the pump beams from each of the pump TDFLs described in Section 3 are positioned around the seed input pigtail fiber. Note, however, that this arrangement may vary as needed or desired.

In some embodiments, all such pigtail fibers entering the input portion of the FC are longitudinally down-tapered as shown in FIG. 7, meaning that the overall outer diameters of such fibers can be reduced along at least a portion of their lengths. The capillary tube can have a similar tapering to support the positioning of the pigtail fibers comprised therein. This tapering of the input pigtail fiber also reduces the outer diameter(s) of the cores and/or claddings of the input pigtail fibers. This tapering reduces the overall combined cross-sectional dimension of the input pigtail fibers and matches or substantially matches their combined cross-sectional dimension to the cross-sectional dimension of the Raman fiber amplifier. In typical embodiments as discussed above, the exit fiber of the FC formed by bundled and tapered FC input fibers forming is fusion-spliced to Raman fiber amplifier downstream. The center area of the FC exit fiber bundle may be accordingly occupied by the core transporting the seed beam from the seed laser.

In some cases, the outer diameters of the cores in the terminal fibers of the TDFLs (constituting input fibers for the FC) may not taper to less than about 10 mm to prevent the mode field guided therein from spreading significantly beyond the core boundaries, which would lead to unwanted optical power loss. To this end, in some embodiments, the cladding of each such FC input pigtail fiber can be etched, such as via treatment with a chemical agent like hydrogen fluoride, to taper the cladding while leaving the size of the core unchanged. In these embodiments, after being etched, the FC input fibers can be fused to each other with minimal or no further down-tapering. In other embodiments, the central fiber entering the FC, which is usually purposed to guide in its core the beam from the seed laser, may exhibit a stepwise refractive index profile around the core, such as when one or more concentric regions or pedestals have refractive indices that increase from the outside towards the center of the input pigtail fiber. Upon down-tapering, the initial core vanishes and is replaced by the surrounding pedestal so as to maintain a constant core size. In still other embodiments, other approaches for fabricating the FC input pigtail fibers can be used.

Although FIG. 7 illustrates one example of FC suitable for a high-power realization of the architecture in FIG. 3, various changes may be made to FIG. 7. For example, various components in FIG. 7 may be combined, further subdivided, replicated, omitted, or rearranged and additional components may be added according to particular needs. Also, the specific wavelengths, materials, dimensions, and other specific details provided above are for illustration only and can vary as needed or desired.

In some embodiments, the laser architecture in FIG. 3 includes 2 pump TDFLs (303), and the generated pulse waveform is used in advanced long-range LiDAR. Each of the two TDFLs features a terminal-amplifier based on a ˜25-30 μm-core Tm-doped fiber and emits a sequence of 1945 nm-wavelength, 1 ns pulses at a PRF=600 kHz, each pulse having energy=0.1 mJ and a corresponding peak power=100 kW. Consistent with these waveform parameters and considering the sum of the outputs generated by the two TDFLs, the total pump pulse energy/peak power is 0.2 mJ/200 kW and the total pump average power is 120 W. The pump TDFLs are pulse time-synchronized.

In some embodiments, the seed laser operates at a 2111 nm wavelength and emits a sequence of 1 ns pulses, time-synchronized and temporally overlapped with the pump TDFL pulses. The seed pulse sequence has a PRF=600 kHz, each pulse is 1 ns-long and the seed pulse energy is 100 nJ, corresponding to pulse peak power=100 W and an average power=60 mW.

In some embodiments, the Raman fiber amplifier exhibits a 25 μm-diameter core and a 40 μm diameter cladding. The pump beams from the TDFLs are fiber-coupled into the Raman fiber amplifier cladding, and the seed beam is fiber-coupled into the Raman fiber amplifier core.

Another application for the Raman fiber laser source disclosed here is directed energy (DE). In these applications, the goal is to generate a laser beam of high average power, typically of the order of 1 kW. Fiber lasers developed for DE applications generally operate in a CW mode, so one might consider increasing the fiber length to the point that a CW pump laser producing only ˜2 kW can yield a gIL product that is sufficient to produce efficient Raman wavelength conversion. But a simple calculation shows that such a fiber length would approach ˜35 m. Given that fiber-laser propagation losses in this target spectral range can become excessive, reaching 80 dB/km or more, the Raman conversion efficiency would suffer an unacceptable drop to ˜45% or worse. In view of this, the present design employs a pulsed waveform that incorporates a pump peak-power level that is sufficiently high to produce a gIL product with an acceptable fiber length no longer than ˜10 m and avoid excessive propagation loss.

In some embodiments, the laser architecture in FIG. 3 includes 15 TDFLs, and the generated pulse waveform is used in directed energy. Each of the fifteen TDFLs features a terminal-amplifier based on a 15 μm-core Tm-doped fiber and emits a sequence of 1945 nm-wavelength, Ins pulses at a PRF=150 MHz, each pulse having an energy ˜0.66 μJ and a corresponding average power ˜100 W. Consistent with these waveform parameters, the total pump pulse energy/peak power is 10 μJ/10 kW and the total pump average power is 1500 W. The pump TDFLs are all pulse time-synchronized.

In some embodiments, based on the laser architecture in FIG. 3, the seed laser operates at a 2111 nm wavelength and emits a sequence of 1 ns pulses, time-synchronized with the pump TDFL pulses. The seed pulse sequence has PRF=150 MHz, each pulse is 1 ns-long and the seed pulse energy is 10 nJ, corresponding to average power=1.5 W.

In some embodiments, the Raman fiber amplifier exhibits a 10 μm-diameter core and 27 μm-diameter cladding. The pump beam from the TDFL is fiber-coupled into the Raman fiber amplifier cladding, and the seed beam is fiber-coupled into the Raman fiber amplifier core.

In some embodiments, the pulse waveform that is used in this example to address directed-energy applications includes (a) high PRF (e.g. 150 MHz) and pulse duty factor (˜15%) to maximize the output average power, which is the quantity most relevant for the efficacy of directed-energy laser sources, and (b) short pulse duration (e.g., 1 ns), which affords suppression of stimulated Brillouin scattering and also results in high spectral brightness suitable for beam combining configurations.

In some embodiments, the Raman-fiber design parameters are optimized for an application, such as directed energy, that require a relatively large pump-cladding area to accommodate the multiple required pump beams. For some applications, the ratio of the pump-cladding area to the area of the desired core fundamental mode, i.e., the cladding-to-mode area ratio (CMAR) need to be in a certain range if one wishes to have a single-Stokes wavelength shift in the output wavelength relative to the pump wavelength. A practical CMAR can be as large as ˜8, depending on the details of the architecture, and assuming a circular geometry, this CMAR limit leads to a limit on the cladding/mode diameter ratio of approximately 2.5-2.8. Assuming the core diameter is 25 μm for the pulsed waveform, as stated in some of the above examples, with an approximate mode diameter of ˜20 μm, an acceptable pump-cladding diameter will be as large as ˜45 μm or more, which offers significant margin above our planned diameter of 35 μm. In applying the CMAR criterion to Raman fiber lasers that might have a range of pump and Stokes wavelengths, the relevant cladding diameter is determined by the longest pump wavelength to be used. Conversely, the relevant Stokes mode diameter in the CMAR is that of the shortest Stokes wavelength to be generated.

An essential function of any high-power fiber design is to favor the fundamental core mode relative to any higher-order modes. This control becomes increasingly challenging as the laser signal power and the core size increase, since the larger core size will support an increasing number of modes that must be suppressed. The present Raman fiber design maintains operation in a single transverse mode by incorporating gain filtering. Gain filtering is achieved by designing the fiber such that the favored fundamental mode in the active fiber laser has a higher gain than any competing mode. Since the base medium of optical fibers in this spectral range is fused silica, which has appreciable Raman gain, the initial state for these fibers is essentially a uniform Raman gain profile across its entire cross-section, independent of the mode shapes.

The first step in modifying the Raman gain profile to achieve gain filtering is to dope the central portion of the fiber with GeO₂, which locally increases the Raman gain in proportion to the GeO₂ concentration. Spatially varying the GeO₂ concentration changes the magnitude and spatial profile of the Raman gain, and this affects the Raman gain of any mode, depending on the mode's spatial overlap with the gain. But the GeO₂ also changes the refractive-index profile, and this changes the shapes of the spatial modes. Therefore, the GeO₂ concentration and spatial profile yield several simultaneous changes: the magnitude of the gain of any mode (i.e. the overlap integral between the mode and the GeO₂), the index profile within the core and, hence, the spatial shapes of the modes and the core NA.

There is still one more degree of freedom, the pump-cladding refractive index, which also affects the core NA and the mode shapes. The required gain filtering is realized by quantifying these dependencies and developing an optimum combination of GeO₂ doping concentration, its spatial profile, a uniform index within the core, the core and pump-cladding diameters, and the core NA (which is also affected by the pump-cladding index). The selection of the amount of GeO₂ concentration may depend on and impact several functions of the Raman fiber and is therefore controlled. For example, GeO₂ concentration affects the Raman gain, the refractive index in the core, the size and shape of the mode profiles. Since the index difference between the core and cladding is relevant, the GeO₂ also affects the cladding refractive index and also the index of the fiber outside of the cladding. In some embodiments, GeO₂ concentration is 8%.

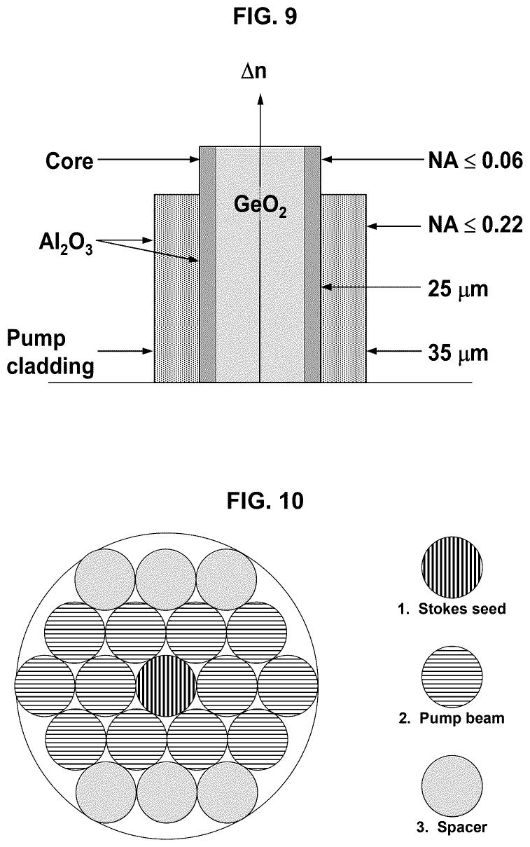

FIG. 9 depicts a cross-section of a gain-filtering fiber, according to some embodiments of the present disclosure. This cross-section of a physical structure that will provide the required gain filtering illustrates refractive-index profile and some exemplary dimensions. Vertical heights represent index change relative to the index of fused silica. Dimensions and NAs are notional and depend on the detailed performance requirements of the Raman fiber laser. As explained above, the GeO₂-doped portion of the core provides the desired fundamental mode with the highest Raman gain. The figure shows that the GeO₂ does not completely fill the core. This schematically represents the fact that the precise fraction of the core that contains the GeO₂ will have to be optimized, in order to maximize the gain enhancement provided by the GeO₂ for the fundamental mode, while also maintaining a lower gain for the higher-order modes by minimizing their spatial overlap of the GeO₂.

Note also that the portion of the core that is outside of the GeO₂ will be doped with alumina (Al₂O₃), a common material for raising the refractive index within silica fibers without affecting the Raman gain. This enables us to achieve a constant index across the entire core, which ensures the minimal distortion of the optical modes. Note also that the alumina concentration in the pump cladding is less than in the core; this index difference is specified to produce the appropriate index step across the core/pump-cladding interface to produce a core NA of 0.06. The physical dimensions in this figure pertain specifically to the high-peak-power laser design. Although the dimensions in the high-average-power design will differ, the basic mode-control method is the same.

The specification of the core and pump-cladding dimensions, along with their NA values, has a substantial impact on the overall performance of the final Raman fiber laser, and in order to succeed, the design secures a balance between specific design elements that tend to push design parameters in different, and occasionally opposite, directions. This section describes designs for both the high-peak-power and high-average-power applications envisioned in this invention disclosure.

The pump-cladding diameter directly affects the pump intensity, and hence the fiber length that is required to achieve a required gIL value: high pump intensities enable short fiber lengths. In the present illustrative example of the high-average power Raman fiber design, we assume that the target output power is 1 kW, and that a total of 12 pump lasers is required.

The properties of the pump fibers are described above in connection with FIG. 4, including the power, beam size, and beam divergence. The individual pump fibers will each generate ˜100 W, enabling the 12 pump lasers to meet the requirement for a total average pump power of ˜1200 W. The area required to contain the 12 pump beams depends on the beam-parameter product (BPP) of each beam, which is defined as the product of the beam size in mm and beam divergence in mrad (both defined at the 1/e 2 values); for a diffraction-limited Gaussian beam at 2110 nm (the longest pump wavelength we will need), the BPP is 3 mm·mrad. The pump cladding BPP capacity is equal to the product of its transverse dimension and NA, and in the present case, this product exceeds twelve times the BPP of a single pump beam. In practical designs, such as the present one, the pump cladding is specified to be somewhat larger to allow for tolerances in the BPP values of the multiple pump beams.

As mentioned above, there is a practical limit on the CMAR. For a given core mode area, the CMAR establishes an upper limit on the pump-cladding area. But for a given set of pump beams, one can reduce the pump-cladding area, in accordance with the CMAR limit, by increasing the pump-cladding NA, but only to the NA limit, which was defined above.

FIG. 10 shows a circular cross section of several pump beams, according to some embodiments of the present disclosure. Given the large number of pump beams required to meet the output-power target for this laser, the pump-cladding design is one of the more challenging elements of the fiber design. Examining the fiber cross-section, the highest packing density of the circular-cross-section pump beams, and therefore the smallest pump-cladding, will be achieved when beams form a close-packed array, as indicated in FIG. 10 for a total of 19 beams. The vertical lines at the center of the array identify the beam that will carry the Stokes seed into the Raman amplifier. The horizontal lines identify the 12 pump beams, and the remaining gray fibers will be discussed below.

For this example of a total of 12 beams, the total BPP across the width of the array must be greater than or equal to 5 times the BPP of a single pump beam. We noted above that each beam will have a BPP of 3 mm·mrad, but in this discussion we will assume the beam quality is 1.1 times diffraction-limited, which will increase the BPP per beam to ˜3.3 mm·mrad, and the total BPP of the width of the pump cladding will be 16.5 mm·mrad. In order to minimize the total cross-sectional area of the pump beams, the NA of the pump cladding will be specified to be relatively high at 0.22, which corresponds to a half-angle acceptance of 220 mrad, and a full-angle acceptance of 440 mrad. The total physical width of the array is then 16.5 mm·mrad/440 mrad=37 μm. This dimension is shared by all of the 5 apertures across the cladding, which allows about 7.5 μm for each beam

In some embodiments, the area of the outer circle that contains all 19 apertures in the figure will be 1075 μm², and a rough estimate of the area that carries the core and the pump beams, i.e., omitting the area of the gray apertures, will be 13/19=68% of the full-circle area, or 735 μm². According to the CMAR requirement above, the required minimum mode area will be˜92 μm², corresponding to mode diameter of 11 μm. Since the mode area scales with the wavelength, the smallest mode area will be for the shortest pump wavelength 1935 nm. A calculation shows that this mode diameter can be achieved with a 10 μm core diameter and a core NA of 0.158. If it were preferred to provide some headroom and operate below the CMAR limit, reducing the core NA to 0.12 or 0.10 for the same 10 μm core diameter would yield mode sizes of 14 and 18 μm, respectively, reducing the CMAR. According to the quantitative estimates summarized above, the gray apertures in the figure are not required and are optional.

As stated above relative to FIG. 9, an exemplary baseline specification for the high-peak-power laser is for the diameter and NA of the core to be 25 μm and 0.06 NA, respectively, and for the pump cladding to be 35 μm and 0.22 NA, respectively. Meeting these specifications requires a specific refractive index profile. In order for the pump cladding to have a NA of 0.22, the index of the outer cladding surrounding the pump cladding must be reduced by 0.0066 relative to pure silica, which can be achieved with approximately 2% doping with fluorine.

In some embodiments, a method for operating the high-power laser inlcudes: operating a seed laser in a first spectral window; operating a plurality of pump lasers in a second spectral window, each including a cladding and comprising of thulium-doped fiber laser (TDFL); combining outputs of the pump lasers and output of the seed laser using a pump/seed combiner having a tapered portion including a cladding; and amplifying the seed laser, using a Raman fiber amplifier having a core and a cladding surrounding the core, to produce an amplified output signal having a wavelength in the first spectral window, wherein the seed laser is launched into the core, and pump laser output beams are launched into the cladding.

In some embodiments, the Raman fiber laser source suppresses unwanted nonlinear optical effects, referred to as “nonlinearities”, in the Raman amplifier fiber.

To suppress these unwanted nonlinearities, the Raman fiber laser source includes a number of design solutions to be implemented in its construction. One such solution pertains to the ability to shape the temporal profile of the pulses in order to minimize the effects of self-phase modulation.

Consider two distinct pulse shapes:

$$\\ \begin{matrix}{f}_{flat - top} ( t ) = \{ \begin{matrix}0 & for & t < - \frac{τ}{2} - {τ}_{0} \\ \frac{t + \frac{τ}{2} + {τ}_{0}}{{τ}_{0}} & for & - \frac{τ}{2} - {τ}_{0} < t < - \frac{τ}{2} \\ 1 & for & - \frac{τ}{2} < t < \frac{τ}{2} \\ 1 - \frac{t - \frac{τ}{2}}{{τ}_{0}} & for & \frac{τ}{2} < t < \frac{τ}{2} + {τ}_{0} \\ 0 & for & t > \frac{τ}{2} + {τ}_{0}\end{matrix} , & ( 3 )\end{matrix}$$

$$\\ \begin{matrix}{f}_{gauss} ( t ) = exp ( - 4 ln 2 \frac{{t}^{2}}{{τ}^{2}} ) . & ( 4 )\end{matrix}$$

Equation (3) defines a peak-normalized flat-top pulse temporal profile having flat portion of duration τ and linearly sloped edges with 0-100% rise/fall time τ₀, and Eq. (4) provides the functional form of a peak-normalized Gaussian profile of full-width at half-maximum pulse width equal to T. The nonlinear optical phase shift, Δφ, characterizing pulses propagating in fiber can be expressed as

$$\\ \begin{matrix}Δ φ ( t ) = \frac{2 π {n}_{2} {P}_{peak} f ( t ) L}{{λ}_{0} \times MFA} . & ( 5 )\end{matrix}$$

Here, n₂ is the fused-silica nonlinear refractive index coefficient (˜2.5×10⁻²⁰ m²/W), Pₚₑₐₖ is the pulse peak power, f (t) is the peak-normalized pulse temporal profile, and L is the fiber length. To obtain Eq. (5), we assumed the pulse peak power and profile to remain constant through the length of the fiber, which is an acceptable approximation for the Raman fiber amplifier if we regard Pₚₑₐₖ as the sum of pump and 1^{st} Stokes pulse power at each point along the fiber and take λ₀ as equal to the average of pump and 1^{st} Stokes wavelength.

The power spectral density, [symbol] (v), corresponding to Eq. (5) can be obtained via Fourier transform:

$$\\ \begin{matrix}𝒫 ( v ) = {\vert {\int }_{- ∞}^{∞} \sqrt{{P}_{peak} f ( t )} exp [ - 2 π i \frac{c}{{λ}_{0}} t + i Δ φ ( t ) ] dt \vert}^{2} . & ( 6 )\end{matrix}$$

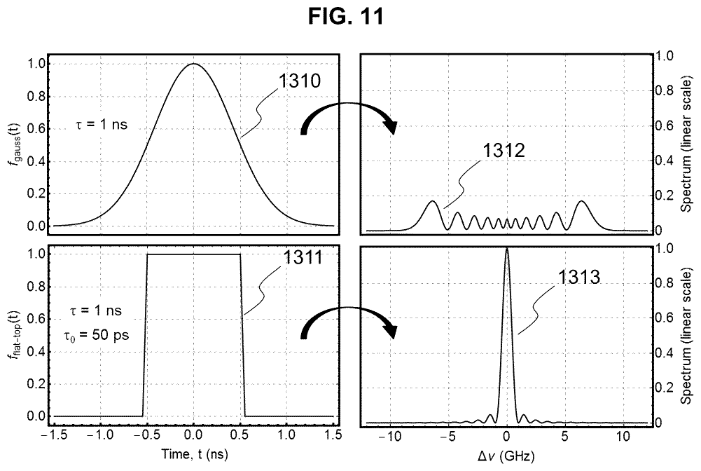

FIG. 11 illustrates the different power spectral densities for pulses having different temporal profiles, but the same peak power, duration and wavelength, propagating through the same fiber, according to some embodiments of the present disclosure. Plot 1310 is a Gaussian pulse temporal profile with a full-width at half maximum τ=1 ns; and plot 1311 is a flat-top pulse temporal profile with a width τ=1 ns and rise/fall time τ₀=50 ps. Plot 1312 is the power spectral density for the Gaussian pulse profile in 1311, plotted as a function of frequency difference Δv relative to the carrier optical frequency, c/λ₀; and plot 1313 is the power spectral density for the flat-top pulse profile in 1312. As shown, the flat-top pulse profile yields a significantly narrower spectrum (higher spectral brightness) compared to the Gaussian pulse. The reason for this difference is that the optical frequency variation vs. time (chirp) induced by the nonlinear phase shift is proportional to the derivative of the pulse shape and is therefore confined to the steep edges of flat-top pulses, which translates into an only small fraction of pulse energy being distributed over the spectral side bands.

In some embodiments, the high-power Raman fiber lasers can suppress the generation of second-Stokes and higher-Stokes production by terminating the Raman medium at an appropriate length where the second-Stokes has not yet been initialized and started to grow, and/or by taking advantage of the natural silica-based propagation loss at the higher-Stokes wavelengths.

It will be recognized by those skilled in the art that various modifications may be made to the illustrated and other embodiments of the disclosure described above, without departing from the broad scope thereof. It will be understood therefore that the disclosure is not limited to the particular embodiments or arrangements disclosed, but is rather intended to cover any changes, adaptations or modifications which are within the scope and spirit of the disclosure as defined by the appended claims and drawings.

1. A high-power Raman fiber laser comprising:
a seed laser configured to operate in a first spectral window;
a plurality of pump lasers, each including a cladding and comprising of thulium (Tm)doped fiber laser (TDFL), and configured to operate in a 1935-2020 nm spectral window;
a pump/seed combiner to combine outputs of the pump lasers and output of the seed laser; the pump/seed combiner having a tapered portion including a cladding; and
a Raman fiber amplifier having a core and a cladding surrounding the core, wherein the seed laser is launched into the core, and pump laser output beams are launched into the cladding, to amplify the seed laser to produce an amplified output signal having a wavelength in the first spectral window, wherein a brightness of the cladding of the Raman fiber amplifier is configured to match to a combined brightness of the plurality of pump lasers.

2. The high-power Raman fiber laser of claim 1, wherein Tm-doping concentration of each of the plurality of pump lasers is equal or greater than 5% wt, and wherein the first spectral window comprises wavelengths in 2100-2200 nm range.

3. The high-power Raman fiber laser of claim 1, wherein a brightness of the Raman fiber amplifier is configured to match to a brightness of the cladding of the tapered portion of the pump/seed combiner.

4. The high-power Raman fiber laser of claim 1, wherein the pump/seed combiner is fusion-spliced with the Raman fiber amplifier.

5. The high-power Raman fiber laser of claim 1, wherein a number of the plurality of pump lasers Nₘₐₓ is given by:
$$\\ \begin{matrix}{N}_{max} = {( \frac{{d}_{R} \times {NA}_{R}}{{d}_{TDFL} \times {NA}_{TDFL}} )}^{2} . & ( 2 )\end{matrix}$$
where, d_{R} and NA_{R} denote the pump-cladding diameter and pump-cladding numerical aperture (NA) of the Raman fiber amplifier, and where d_{TDFL} and NA_{TDFL} denote the core diameter and core NA of the terminal fiber in each of the pump TDFLs.

6. The high-power Raman fiber laser of claim 1, wherein the seed laser is configured to output a sequence of pulses having a duration of 1-3 nano seconds or shorter that are time-synchronized and temporally overlapped with pulses produced by the plurality of pump lasers.

7. The high-power Raman fiber laser of claim 6, wherein a pulse waveform corresponding to the sequence of pulses output by the seed laser comprises a high pulse repetition frequency of 100 MHz or higher and a pulse duty factor of 1% or higher.

8. The high-power Raman fiber laser of claim 1, wherein a cladding-to-mode area ratio (CMAR) of the Raman fiber amplifier is selected to limit a cladding to mode diameter ratio between 2.5-2.8.

9. The high-power Raman fiber laser of claim 1, wherein the core of the Raman fiber amplifier has an effective fundamental-mode field diameter of 5 μm or greater.

10. The high-power Raman fiber laser of claim 1, wherein the Raman fiber amplifier is configured such that a favored fundamental mode in the Raman fiber amplifier has a higher gain than any other mode in the Raman fiber amplifier.

11. The high-power Raman fiber laser of claim 1, wherein a central portion of the core of Raman fiber amplifier is doped with GeO₂, and wherein a fraction of the core diameter including the GeO₂ doping and a magnitude of the GeO₂ concentration within the fraction of the core diameter, are both varied to achieve a desired gain filtering.

12. The high-power Raman fiber laser of claim 8, wherein a portion of the core of Raman fiber amplifier that is outside of the GeO₂ doping is doped with alumina (Al₂O₃).

13. The high-power Raman fiber laser of claim 1, wherein a desired gain filtering in the Raman fiber amplifier is achieved based on at least two of: GeO₂ concentration in the core, spatial variation of the GeO₂ concentration between a plurality of regions of the core, a pump-cladding refractive index, core and pump-cladding diameters, and the core and cladding numerical apertures.

14. A method for operating a high-power laser, the method comprising:
operating a seed laser in a first spectral window;
operating a plurality of pump lasers in a second spectral window, each including a cladding and comprising of thulium-doped fiber laser (TDFL);
combining outputs of the pump lasers and output of the seed laser using a pump/seed combiner having a tapered portion including a cladding; and
amplifying the seed laser, using a Raman fiber amplifier having a core and a cladding surrounding the core, to produce an amplified output signal having a wavelength in the first spectral window, wherein the seed laser is launched into the core, and pump laser output beams are launched into the cladding.

15. The method of claim 14, wherein Tm-doping concentration of each of the plurality of pump lasers is equal or greater than 5% wt, and wherein the first spectral window comprises wavelengths in 2100-2200 nm range and the second spectral window comprises wavelengths in 1935-2020 nm range.

16. The method of claim 14, wherein a brightness of the pump cladding within the Raman fiber amplifier is configured to match to a combined brightness of the plurality of pump lasers.

17. The method of claim 14, wherein the seed laser is configured to output a sequence of pulses having a short duration of 1-3 nano seconds or shorter, that are time-synchronized and temporally overlapped with pulses produced by the plurality of pump lasers.

18. The method of claim 14, wherein a cladding-to-mode area ratio (CMAR) of the Raman fiber amplifier is selected to limit a cladding to mode diameter ratio between 2.5-2.8.

19. The method of claim 14, further comprising doping a central portion of the core of the Raman fiber amplifier with GeO₂, wherein a fraction of the core diameter doped with GeO₂ and a magnitude of the GeO₂ concentration within the fraction of the core diameter are varied to achieve a desired gain filtering.

20. The method of claim 14, further comprising: controlling gain filtering in the Raman fiber amplifier based on at least two of: GeO₂ concentration in the core, spatial variation of the GeO₂ concentration between a plurality of regions of the core, a pump-cladding refractive index, core and pump-cladding diameters, and the core and cladding numerical apertures.
